(19) United States
(12) Patent Application Publication
(10) Pub. No.: US 2006/0182855 A1
(43) Pub. Date: Aug. 17, 2006

(54) Preparation of coated powder

(76) Inventors: John Van De Sype, Semmerzake (BE); Ravindra L Arudi, Woodbury, MN (US)

Correspondence Address: CARGILL, INCORPORATED, LAW/24, 15407 MCGINTY ROAD WEST, WAYZATA, MN, 55391, US

(21) Appl. No.: 10/564,398

(22) PCT Filed: Jul. 24, 2003
(86) PCT No.: PCT/US03/23308

§ 371 Date: Jan. 12, 2006

(51) Int. Cl. A23L 2/00

(52) U.S. Cl. 426/330.6

(57) ABSTRACT

There are disclosed baked food products containing specific lecithin products.

### CROSS REFERENCE TO RELATED APPLICATIONS

This application is a continuation-in-part application of U.S. application Ser. No. 10/202,294 that was filed with the United States Patent and Trademark Office on Jul. 23, 2002.

### FIELD OF THE INVENTION

The present invention relates to the production of particles coated with a specific lecithin product that have good wettability and/or dispersibility.

### BACKGROUND OF THE INVENTION

There is available much information related to treating or coating powders of many types in order to improve the reconstitution properties, such as wettability and dispersibility, in water. Various types of lecithin have been utilized as coatings for the powders. There is, however, a continuing attempt to improve the properties of wettability and dispersibility, and it would be advantageous if such solutions were provided.

### SUMMARY OF THE INVENTION

The present invention relates to the production of powders coated with a specific lecithin, such that the coated particles have good wettability and dispersibility. The lecithin products that are used in coating the powders, in a first embodiment, are membrane, separated lecithins having a ratio of alkali metals to alkaline earthmetals ranging from greater than 0 to about 10 and preferably greater than 0 to about 5. In a second embodiment the lecithin products used in the present invention are described as lecithins having a ratio of alkali metals to alkaline earthmetals ranging from about 1.6 to about 3.0, preferably about 1.8 to about 2.8.

### DETAILED DESCRIPTION OF THE INVENTION

The present invention relates to the production of powders coated with a specific lecithin, such that the coated particles have good wettability and dispersibility. The lecithin products that are used in coating the powders, in a first embodiment, are membrane, separated lecithins having a ratio of alkali metals to alkaline earthmetals ranging from greater than 0 to about 10 and preferably greater than 0 to about 5. In a second embodiment the lecithin products used in the present invention are described as lecithins having a ratio of alkali metals to alkaline earthmetals ranging from about 1.6 to about 3.0, preferably about 1.8 to about 2.8.

In the present process for producing coated particles, any particle may be used. Exemplary of the particles that are suitable for use in the present process are the following:

| | |
|---|---|
| Cocoa powder | Soy isolate |
| Flour | Instant breakfast beverage |
| Soups | Ice tea |
| Jell-O | Processing aid for gums dispersal |
| Insoluble fiber | Infant formulas |
| Thickeners | Snack food coating |
| High intensity sweeteners | Beta Glucan |
| Steryl Esters | Sauces |
| Gravy | Sodium Caseinate |
| Milk Powders | PreBlends (Powder gravies, salad |
| | dressings, mixes, high protein |
| | powders) |
| Nutritional Powders | Powders in oils |
| Fats into oils | Salad dressings |
| Pharmaceutical applications | Food Colors |
| Cheese Powder | Spice Blends |
| Marinades | Yeast |
| Flavor Emulsions | Enterals |
| Dessert mixes | Cake mixes |
| Muffin mixes | Bullion cubes |
| Leavening agents | Powdered Eggs |
| Sucrose | Aspartame |
| Powdered laundry detergent | Pancake mixes |
| Chemical sprays (Fruit trees) | Fertilizers |
| Drugs | Fire extinguisher |
| Colloidal Suspension | Beauty products |
| Hair dyes | Inks |
| Custard | Finger Paints |
| Easter egg dyes | Pudding/healthy/chocolate |
| Seed Alcohol Coatings | Confections |
| Powdered Sugar | Pool/hot tub chemicals |
| Bubble bath | Colloidal materials for bath powder |
| Anti-foaming agent | Shakers |

In the present process, the powders are coated in any suitable manner with a specified lecithin product, in the form of an oil-containing lecithin, or a lecithin with oil, or a water-containing lecithin or a lecithin with aqueous phase such as water.

The lecithin products used in the present invention may be prepared by any suitable manner. For example, a vegetable oil miscella may be passed through a membrane, preferably polymeric or semi-permeable, to obtain a retentate and a permeate. The lecithin products are in the retentate. Exemplary of such methods are those appearing in U.S. Pat. No. 6,207,209 to Jirjis, et al.; U.S. Pat. Nos. 4,496,498 and 4,533,501 to Sen Gupta.

Specific examples describing the preparation of lecithin products of the invention are provided as follows:

### EXAMPLE A

Two samples of miscella were prepared by using the present technique. Miscella samples were obtained from two different oil seeds plants.

A membrane was conditioned and used for removing phospholipids from each of the two samples of miscella. The membrane purchased was a PAN membrane from Osmonics, Inc. The membrane can be characterized as having an average pore size of 0.3 micron, and in the form of a spiral wound 25 inch×40 inch membrane element. The membrane was conditioned by soaking the membrane in an intermediate solvent (propanol) for 24 hours. Then the membrane was soaked in mixture of intermediate solvent (propanol) and extraction solvent (hexane) for 24 hours. Finally, the membrane was soaked in extraction solvent (hexane) for 24 hours.

The two samples of miscella were individually processed. For the soybean oil miscella, the test was conducted at retentate concentration of 10× of the feed concentration and the permeate rate of 10× concentration was 100 liter/hour m². For the corn miscella, the test was conducted at retentate concentration of 7.4× of the feed at a permeate rate of 80 liter/hour m².

### EXAMPLE B

Samples of soybean oil miscella were taken on different days and were treated by using the present technique.

Spiral wound 8 inch×40 inch QX membranes were purchased from Osmonics, Inc. The membranes were conditioned and used for removing phospholipids by soaking them in an intermediate solvent (100% isopropanol) for 12 hours. At 6 hours, the intermediate solvent was recirculated at a flow rate of 15 m³/hour per element and forced through the membrane pores for about 15 minutes using a pump (this recirculation or forcing through is referred to as “forced Permeation” for purposes of the Example B). Then the resulting membrane was soaked in a 50:50 mixture of intermediate solvent (100% isopropanol) and extraction solvent (100% commercial hexane) for 12 hours. After 6 hours this soaking included recirculation at a flow rate of 15 m³/hour per element and forced permeation for about 15 minutes. Finally, the resulting membranes were soaked in extraction solvent (100% commercial hexane) for 12 hours, also with recirculation and forced permeation of the extraction solvent at 6 hours for about 15 minutes with 15 m³/hour recirculation flow. The resulting membranes treated with this process are “conditioned membranes” for purposes of this Example B.

The soybean miscella containing about 75 wt. % hexane, 24.3 wt. % crude oil, and 0.7 wt. % phospholipids, was passed through the first conditioned membrane at a trans-membrane pressure of 4 Kfg/cm² at a rate of 0.6 m³/hour per element. The resulting retentate stream had about 7 wt. % phospholipids and 23 wt. % oil (i.e., the test was conducted at retentate concentration of 10× of the feed concentration). Excess hexane was added to this retentate in the proportion of 2 portions of hexane to 1 portion of retentate resulting in a stream containing 88 wt. % hexane. This retentate stream was passed through a second conditioned membrane at a trans-membrane pressure of 4 Kgf/cm² at a rate of 0.35 m³/hour per element, resulting in a retentate stream having about 65 wt. % hexane, 23 wt. % phospholipids and 12 wt. % oil which is equivalent to lecithin free of hexane with 66% acetone insolubles. This retentate stream was desolventized at a rate of 1800 kg/hour, 95° C. and 260 mm Hg absolute pressure. The resulting concentration of hexane was 5%. The retentate stream was further desolventized at a temperature of 110° at an absolute pressure of 20 mm Hg and sparge stream of 80 kg/hour by using a stripper to product 600 kg/hour of lecithin product with less than 5 ppm of hexane.

In determining the content of the alkali metals and alkaline earthmetals of the lecithin product, the following test procedure is used.

Elemental Analysis Standard Procedure SRC

Elemental analysis was performed by Inductively Coupled Plasma-Emission Spectroscopy (ICP-ES) with target elements of aluminum, calcium, chromium, iron, lead, magnesium, nickel, potassium, phosphorus, silicon, sodium, and zinc. This analysis was performed according to the American Oil Chemists' Society (AOCS) Official Method Ca 20-99. Each sample was weighed on an analytical balance to the nearest 0.0001 g. Because of the range of concentration, two dilution levels are required. Approximately 0.8 g of sample was weighted out and recorded. To the sample approximately 4.2 g of kerosene was weighed and recorded. The sample/kerosene mixture was vortexed until the sample is completely dissolved. Approximately 4.2 g mineral oil was added to the sample/kerosene solution and recorded. This concentration is used to analyze the lower level elements, Al, Cr, Fe, Pb, Na, Ni, Si, and Zn. For the higher concentration elements, Ca, Mg, P and K, another dilution is made by taking approximately 0.5 g of the first dilution, recording the weight, and adding approximately 9.5 g of a 50/50 kerosene/mineral oil and record the total weight. All of the final dilutions are mixed until homogeneous. The samples are placed into a heated, 40° C., sample hot plate along with the standards and allowed to come to temperature, approximately 10 minutes, prior to the introduction into the ICP. Samples were run in triplicate.

Calculation:

The ICP data is reported typically as ppm calcium, magnesium, potassium, sodium and phosphorous, along with other metals. The ppm values are divided by the atomic weight of the respective element (Ca:40, K:39, P:31 and Mg:24) and the atomic equivalents are used to calculate the ratio of monovalent to divalent (alkali metals to alkaline earthmetals).

In the present process, the lecithin coating may be applied to the substrate by any conventional manner. For example, in U.S. Pat. No. 3,291,614, several methods for applying a lecithin to a powder are shown. In one instance it is stated that whole milk powder is coated with a spray of soybean lecithin-water emulsion. In another process, a powder was mechanically blended with a solution of soybean lecithin in an equal amount of soybean oil.

When applying the lecithin with water, the composition may contain lecithin in an amount of greater than 0 to about 30% by weight. When applying the lecithin with an oil such as soybean oil, the composition may contain from greater than 0 to about 95% by weight of lecithin. In any instance, the amount of lecithin to be applied to the powder, including use with water or oil, will be an amount that is sufficient to coat the powder. It is clear that any aqueous phase, not only water, can be used, and that any vegetable oil, not only soybean oil, can be used with the lecithin, as a method for applying the lecithin to the powder.

The lecithin used in the present invention can be derived from any vegetable oil, which may be solid or liquid at ambient temperature. Suitable vegetable oils for use include, for example, soybean oil, sunflower oil, rapeseed oil, cottonseed oil, olive oil, corn oil, ground nut oil, safflower oil, linola oil, linseed oil, palm oil, coconut oil, and mixtures thereof. Particularly useful is soybean oil. Suitable oils of animal origin for use include, for example, butter fat and fish oil. The total of the animal fats should be below 30 wt. % of total oils in the food composition.

The following examples are presented to illustrate the present invention and to assist one of ordinary skill in making and using the same. The examples are not intended in any way to otherwise limit the scope of the invention.

### EXAMPLES

In carrying out the following example, the following test procedures were used: Wettability—In this procedure a powder is brought into water. The wettability is the amount of time lapsed to wet all the powder. The apparatus required for the test includes a 1000 ml glass beaker, a plastic plate (0.12 m×0.12 m), and a cylinder having a diameter of 0.075 m and a height of 0.065 m.

In carrying out the wettability test, the following procedure is used;

(1) Ten (10) g of powder is weighed into a jar and immediately closed;

(2) The powder is shaken by hand to reduce any lump formation;

(3) Pour 500 ml demineralized water at a temperature of 25° C. into a beaker;

(4) Put the plastic plate on the beaker, and put the cylinder on top of the plate;

(5) Bring the weighed sample into the cylinder and spread the product equally over the surface of the cylinder;

(6) Start a timer;

(7) After one minute, pull the plate away from the cylinder, and the powder falls into the water;

(8) Determine the time elapsed when the powder is wetted;

(9) Calculate the time of wetting from the equation Time of wetting(s)=total time(s)−60 s

### Example 1

In this example a lipophylic powder, GERKENS cocoa cake, DP 70 10/12% fat, available from Cargill, Inc. is coated with a lecithin of the invention to improve wettability. The lecithin used was a membrane separated lecithin having a ratio of alkali metal to alkaline earthmetals of about 2.4, and containing about 35 to 40% soybean oil.

The example is carried out by placing 500 g of the cocoa cake in a Hobart mixer Model N50CE. The cake is mixed on position two (2) with a butterfly blade in the Hobart mixer. There is added 5% by weight (42 grams) of the lecithin to the cake over a one (1) minute period, with mixing. The mixing is continued for another two (2) minutes. The lecithin-coated cake is ground in an IKA grinder Universal Muhle M20, to a fine powder. During the grinding the IKA grinder is cooled with tap water. The resulting finely ground lecithin-coated cocoa powder is then tested for wettability.

In accordance with the test procedure, the lecithin-coated cocoa powder required 2 to 2.5 minutes for total wetting. By comparison, the same cocoa cake, in the absence of the lecithin coating exhibited no wettability.

### Example 2

In this example, a hydrophilic powder, whole milk powder, BBA Lactalis Industry, 26% fat content is coated with a membrane separated lecithin having a ratio of alkali metals to alkaline earth metals of about 2.4, and containing about 58 to 72% soybean oil.

In carrying out the process, 250 g of whole milk powder is placed into a GEA Model Strea 1 Aeromatic Fielder Fluidizer. The powder is fluidized with inlet air (air capacity put on position 6.5). Then, 0.5 weight % of the lecithin is pumped, with the peristaltic pump on position 8, and sprayed onto the fluidized powder with a spraying nozzle (atomizing pressure at one (1) bar). The outlet air is 30-40° C. After the addition of the lecithin, the powder is still fluidized for one (1) minute.

The whole milk powder coated with 0.5% lecithin is tested for wettability, and it is found that a period of four (4) to six (6) minutes is required for total wetting. By comparison, in the absence of the lecithin, the milk powder exhibits no wettability.

Example 3

Three hundred (300) grams of a soy protein isolate powder having an average particle size of 50 microns was injected in a high velocity air stream into a fluid bed coating chamber. The fluidized powder was sprayed with 40 g of a 15% aqueous dispersion of soybean lecithin having 2% oil and having a ratio of alkali metals to alkaline earthmetals of 2.5, at a spray rate of 14 g/minute with inlet/outlet temperatures at 55/25C, air flow of 8-10 SCFM and spray air pressure set at 10 psi. After coating, the lecithin coated soy protein isolate powder was transferred into a container. Three (3) grams of the product was added to 150 g cold water and gently stirred by hand with frequently reversing of the direction, noting down the time taken for complete dispersion of the powder. The control uncoated sample required more than 240 seconds to disperse, in water measured by the procedure described, while the lecithin coated product dispersed completely in seven (7) seconds. The powder flow properties were not severely degraded as shown by the absence of bridging or caking and bulk density decrease from 0.41 to only 0.39 g/ml.

### Example 4

Five hundred (500) grams cocoa with 10-12% fat and average particle size 20-30 microns was injected in a high velocity air stream into a fluid bed coating chamber (FluidAIR Magnaflo Model 2). The fluidized powder was sprayed with 100 g of 15% aqueous dispersion of lecithin having 28% oil and a ratio of alkali metals to alkaline earthmetals of 2.4 with the following process conditions:

Inlet-outlet temperatures of 50C/30C, spray air pressure of 8 psi, airflow 8-10 of SCFM, and spray rate of 15 g/min. The control cocoa powder with no coating required more than 200 seconds to disperse in water measured by the procedure described, while the lecithin-coated cocoa sample took only 24 seconds for complete dispersion.

From the examples, it is apparent that powders treated with the specific lecithin products described in this invention are more wettable and dispersible than the untreated powders.

The invention has been described with reference to various specific and illustrative embodiments and techniques. However, one skilled in the art will recognize that many variations and modifications may be made while remaining within the spirit and scope of the invention.

We claim:

1. A process for treating a powder comprising applying to the powder a coating comprising a membrane separated lecithin having a ratio of alkali metals to alkaline earthmetals ranging from greater than 0 to about 10.

2. The process according to claim 1 wherein the ratio of alkali metals to alkaline earthmetals ranges from greater than 0 to about 5.

3. The process according to claim 1 wherein the lecithin is used in the form of a water composition comprising lecithin in an amount of greater than 0 to about 30% by weight.

4. The process according to claim 1 wherein the lecithin is used in the form of an oil composition comprising lecithin in an amount of greater than 0 to about 100% by weight.

5. The process according to claim 1 wherein the amount of coating applied to the powder is an amount sufficient to coat the powder.

6. A process for treating a powder comprising applying to the powder a coating comprising a lecithin having a ratio of alkali metals to alkaline earthmetals in monovalen or divalent ionic state ranging from about 1.6 to about 3.0

7. The process according to claim 6 wherein the ratio of alkali metals to alkaline earthmetals ranges from about 1.8 to about 2.8.

8. The process according to claim 6 wherein the lecithin is used in the form of a water composition comprising lecithin in an amount of greater than 0 to about 30% by weight.

9. The process according to claim 6 wherein the lecithin is used in the form of an oil composition comprising lecithin in an amount of greater than 0 to about 100% by weight.

10. The process according to claim 6 wherein the amount of coating applied to the powder is an amount sufficient to coat the powder.

11. A product produced in accordance with claim 1.

12. A product produced in accordance with claim 6.

13. A process for improving the wettability and dispersibility of a powder comprising applying to the powder a coating comprising a membrane separated lecithin having a ratio of alkali metals to alkaline earthmetals ranging from greater than 0 to about 10.

14. A process for improving the wettability and dispersibility of a powder comprising applying to the powder a coating comprising a lecithin having a ratio of alkali metals to alkaline earthmetals ranging from about 1.6 to about 3.0.
